(19) United States
(12) Patent Application Publication
(10) Pub. No.: US 2024/0052473 A1
(43) Pub. Date: Feb. 15, 2024

(54) MULTI-JET AIR KNIFE

(71) Applicant: TATA STEEL NEDERLAND TECHNOLOGY B.V., Velsen-Noord (NL)

(72) Inventor: Jaap Peter VAN EENENNAAM, HEILOO (NL)

(73) Assignee: TATA STEEL NEDERLAND TECHNOLOGY B.V., Velsen-Noord (NL)

(21) Appl. No.: 18/257,744

(22) PCT Filed: Nov. 26, 2021
(86) PCT No.: PCT/EP2021/083162

§ 371 Date: Jun. 15, 2023

(30) Foreign Application Priority Data
Dec. 22, 2020 (EP) 20216574.2

(51) Int. Cl. C23C 2/20

(52) U.S. Cl. CPC C23C 2/20

(57) ABSTRACT

A multi-slot gas wiping device for controlling the thickness of a molten metallic coating on a moving metal strip. The device including a nozzle system.

### FIELD OF THE INVENTION

The present invention relates to a multi-slot gas wiping device for controlling the thickness of a molten metallic coating applied on a metal strip.

### BACKGROUND OF THE INVENTION

Gas wiping devices are used to control the thickness of a metallic coating applied on a moving metal strip, such as a steel strip. The metallic coating is applied by means of hot dip coating wherein in a continuous or semi-continuous process a metal strip passes as part of the process through a bath of molten metal of for instance Zn, Zn+Fe alloy, Zn+Al or Zn+Mg+Al. The metal strip leaves the bath in an about vertical direction after which the excess of the applied metallic coating is blown off with a high pressure air/gas wiping device also known as “air knife”. The removal of excess metallic coating from the moving strip is in fact the control of the thickness of the applied metallic coating.

As the metallic coating is applied before the final manufacturing from the coated steel strip of for instance outer parts for the automotive industry the applied coating should fulfil requirements like an exact predefined thickness and uniform thickness over the complete coated steel strip. This is important not only to be able to subject the coated steel strip to forming operations but also for the final appearance of the final steel product formed from the coated steel strip.

These requirements mean that the gas wiping device should discharge a uniform gas jet over the total width of the gas nozzle of the gas wiping device which means that the gas jet should be of uniform velocity and pressure. This implies high standards for the construction of the gas wiping device and its gas discharge nozzle.

By nature the flow of the discharge nozzle, also known as air knife jet, is unstable, which leads to an uneven surface in galvanizing manifesting as orange peel. Such a flow may be stabilized using auxiliary jets. EP3190204 for example discloses a method for manufacturing molten metal plated steel strip.

A drawback of multi-jet air knifes is that the pressure gradient may be lower and therefore, the wiping efficiency would be adversely affected by adding auxiliary jets. Therefore, limited efforts have been undertaken to manufacture such a device for a commercial galvanising line.

Recently, it has been demonstrated with computational studies that the geometry of the gas wiping device can be modified to achieve a similar or even higher pressure gradient and thus, a higher wiping efficiency and lower coating weights (Yayhaee et al, JCTR 2017). The coating weight can be influenced by the knife to strip distance, the angle of the primary and auxiliary jets, the gap width of the primary and auxiliary nozzles and the separation between the main- and auxiliary jets. A higher wiping efficiency requires a tilt angle between the auxiliary jet and the main jet. In addition, CFD has shown that the inlet pressure of the auxiliary jet flow rate should be a fraction of the flow rate of the main jet. Compared to a conventional air knife, this configuration will need longer nozzles to achieve the same flow rate at the primary nozzle, resulting in a lower stiffness of the nozzle and an unstable air flow.

It is therefore desirable to provide a multi-jet air knife that has a stable air flow and a high wiping efficiency for a commercial galvanising line.

### Objectives of the Invention

It is therefore an object of the invention to provide a multi-jet air knife with two separate air flows.

It is also an object of the invention to provide a multi-jet air knife with sufficient stiffness.

It is also an object of the invention to provide a multi-jet air knife that can be easily assembled and disassembled.

It is also an object of the invention that the nozzle of the multi-jet air knife can be easily exchanged, and the gap setting can be adjusted separately.

It is also an objective of the invention to provide a multi-jet air knife with a modular design.

It is also an objective of the invention to provide a multi-jet air knife which can be used in a commercial galvanising line.

### DESCRIPTION OF THE INVENTION

One or more of these objectives are reached with a multi-slot gas wiping device according to claim 1-15.

In the first aspect, there is provided a multi-slot gas wiping device for controlling the thickness of a molten metallic coating on a moving metal strip, comprising
a nozzle system with a primary nozzle with a first elongated opening and two auxiliary nozzles each with an auxiliary elongated opening, wherein the primary nozzle and auxiliary nozzles are parallelly arranged, and
wherein the nozzle system comprises two nozzle components (10a, 10b) attached together with a shim (8), thereby defining the first elongated opening with a gap width d, and
wherein each nozzle component comprises an inner part and an outer part, defining the auxiliary elongated openings with a gap width dₐ, and
   wherein each inner part comprises an inner nozzle lip (1a, 1b) and two outer ends at the inner nozzle lip (3a, 3b) and
   wherein each outer part comprises an outer nozzle lip (2a, 2b), two outer ends at the outer nozzle lip (4a, 4b) and a plurality of supports (5a, 6a, 7a), wherein the plurality of supports are integrated in the outer nozzle lips (2a, 2b) with a perpendicular orientation to the outer nozzle lip.

Advantageously, the nozzle system of the wiping device comprises two nozzle components, each nozzle comprising an inner part and an outer part, In this way, a modular design has been drafted that allows for a primary nozzle with two auxiliary nozzles, which are parallelly arranged. The present invention therefore provides a device of great simplicity which can be easily implemented in a commercial galvanizing line. Sufficient stiffness, and hence a stable air flow, is introduced via the plurality of support in the outer nozzle lips. The amount, shape and thickness of the supports is not particularly limited. Preferably the supports are spaced at an interval in a range of 5-15 cm, preferably in a range of 5-10 cm. The density of the supports is preferably at least supports per meter length. In a preferred embodiment, the supports are spaced at an even interval over the length of the nozzle lip.

It should be noted that the wiping device according to the invention as such is a multi-slot air-knife comprising a main jet and an auxiliary jet. The definitions wiping device and air-knife can be used interchangeably.

The length of the gas wiping device is not particularly limited and should preferably be chosen such that it can accommodate the widest strip size, typically up to 2500 mm.

To obtain lower coating weights, the arrangement for the multi-slot air-knife should be such that the centreline of the main and the auxiliary jet coincide at a same point on the strip. This can be influenced by the knife to strip distance (Z), the angle α of the inner nozzle lips, the angle β of the outer nozzle lips, the gap width of the primary nozzle (d), the gap width of the auxiliary nozzle (dₐ) and the separation (a) between the main- and auxiliary jets.

In an embodiment, the inner and outer part of the nozzle components of the gas wiping are detachable connected. This allows for an easy exchange of the nozzle and has the advantage that the gap width dₐ of the auxiliary nozzle can be easily adjusted according to the required specifications. The gap width dₐ of the auxiliary nozzle may be determined by an offset at the outer ends of the outer nozzle lip or by an indentation of the outer nozzle lip. Preferably, the outer part itself is made in one piece, for ease of manufacturing.

In an embodiment, the nozzle components are detachable connected. This allows for an easy exchange of the nozzle and allows for an easy adjustment of the gap d of the primary nozzle, for example by changing the shim.

As such the nozzle system can be made of four modular parts, which can be easily assembled together.

In a preferred embodiment, the inner nozzle lips are tilted at an angle α in the range of 10-20° measured from the centreline. The angle α is preferably in the range of 10-20°, more preferably 15°, such that the highest impingement pressure on the strip can be achieved.

In a preferred embodiment, the outer nozzle lips are tilted at an angle β in the range of 20-40° measured from the centreline. The angle β is preferably in the range of 10-20°, more preferably 15°, such that the highest impingement pressure on the strip can be achieved.

In a preferred embodiment the two nozzle components are mirror images of each other. By having two nozzle components which are mirror images of each other, the manufacturing process becomes easier. In addition, such a configuration will result in a stable air flow.

In a preferred embodiment the plurality of supports in the outer parts are chamfered at the nozzle opening in a range of 4-12°, in order to reduce vortex shedding, corresponding to an encapsulated angle at a range of 8-24 degree. Preferably the supports are chamfered in a range of 6-10°, most preferably at 8°.

In a preferred embodiment the first elongated opening is fed with a first pressurized gas and the auxiliary elongated openings are fed with a second pressurized gas. The gas flow in the auxiliary jets is preferably lower than the gas flow to the main jet. Preferably the gas flow of the second pressurized gas is 20% of the gas flow of the main jet.

In order to provide separate gas flows, flow regulator means can be provided. As the auxiliary jets are being attached directly on the main nozzle an air knife design with separate gas feeding for both the main and auxiliary nozzle is preferred. This can be realized by adding a casing to the nozzle which can lead the wiping gas to the nozzles Preferably, separate feeding channels for the pressurized gas for both the main and the auxiliary nozzles are provided.

In a preferred embodiment, the gas wiping device comprises a casing with two compartments, configured as such that the first pressurized gas is guided through a first compartment to the first elongated opening and the second pressurized gas is guided through a second compartment to the auxiliary elongated openings. The casing can be mounted to the nozzle to lead the wiping gas to lead the wiping gas to the nozzles.

The main jet can be fed from one or two sides of the air knife or from the back. The auxiliary jets can be fed from the back or from one or two sides, or from the top of the air knife. Preferably one wiping gas is provided at the outer sides of the casing and the other wiping gas via the back, as this set up will fit the configuration of most hot-dip galvanizing plants.

Preferably, the casing comprises gas inlets at the outer sides in fluid connection with the first compartment. Preferably, the casing of the gas wiping device comprises a gas inlet at the back in fluid connection with the second compartment to supply wiping gas to the auxiliary jets, to prevent too high maximum gas velocity and pressure drop. It has been chosen to feed the wiping gas for main jet on both sides of the casing and the auxiliary jets from the back. As feeding the auxiliary nozzle from the sides would possibly lead to too high maximum gas velocity and pressure drop.

In a preferred embodiment, the first compartment of the casing comprises calibration means. Prior to the main nozzle calibration means are preferably added to break vortices present in the flow to the main nozzle. Preferably, calibration holes should be added to break vortices present in the flow before entering the main nozzle.

In a preferred embodiment, the second compartment of the casing comprises a plurality of supports. The plurality of supports will achieve a higher stiffness in the ducts to the auxiliary nozzles, ensuring a more stable air flow.

In a preferred embodiment, the plurality of supports of the casing are aligned with the plurality of supports of the outer part of the nozzle components. By aligning the supports the air flow will be most stable.

In a preferred embodiment the plurality of supports of the casing are chamfered at the gas inlet at the back to reduce vortices. Preferably the plurality of supports of the casing are chamfered in a range of 4-12°, more preferably in a range of 6-10°, most preferably at 8°.

In a preferred embodiment the ratio of the Reynolds number of the first pressurized fluid to the second pressurized fluid is in the range of 2:1 to 10:1, preferably 4:1 to 8:1, most preferably 6:1. The pressurized fluids are not particularly limited and can be air, nitrogen, CO2, or argon. Preferably the pressurized fluid is air or nitrogen.

### FIGURES

The invention is further explained by the following figures.

FIG. 1 Shows an exemplary embodiment of a nozzle system of a wiping device according to the invention.

FIG. 2 Shows details B and G of the exemplary embodiment of FIG. 1.

FIG. 3 Shows an exemplary embodiment of a wiping device according to the invention.

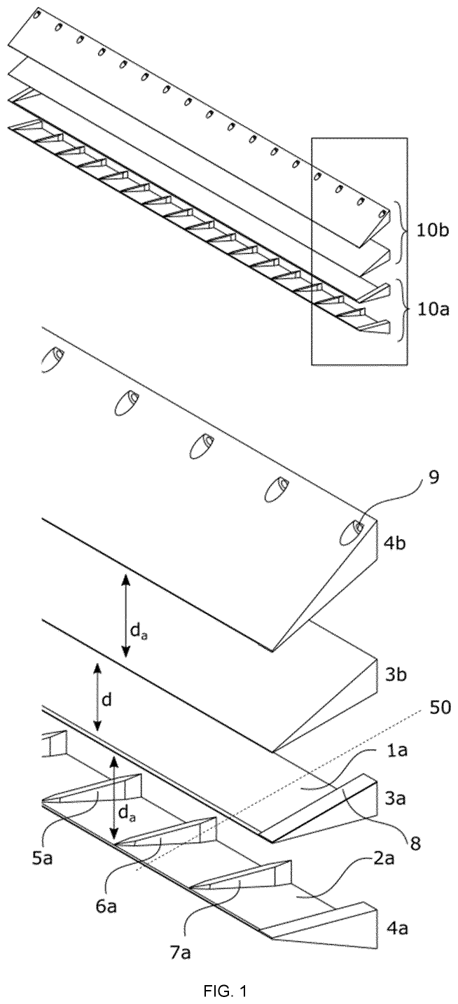

FIG. 1 Shows an exploded view of an exemplary embodiment of a nozzle system of a wiping device according to the invention. The nozzle system comprises two nozzle components 10a and 10b, each comprising two inner parts and two outer parts. Each inner part comprises an inner nozzle lip 1a, 1b and two outer ends 3a, 3b, thereby forming an envelope. The inner parts are detachable connected with a shim (8). By varying the size of the shim the gap d of the first elongated opening can be set. The gap d is typically between 0.5-5.0 mm, and is set according to the coating requirements of the final product. Each outer part comprises an outer nozzle lip 2a, 2b, two outer ends 4a, 4b and a plurality of supports 5a, 6a, 7a. The plurality of supports are preferably perpendicular to the outer nozzle lips. The supports have a width of 0.4-20 mm each and are preferably spaced apart evenly over the length of the wiping device, to provide stiffness to the wiping device. The outer part is detachable connected to the respective inner part, for example with fasteners through the supports. The gap width dₐ of the auxiliary elongated opening is defined by an offset at the outer ends at the outer nozzle lip or by an indentation of the outer nozzle lip. By varying the size of the offset and or the indentation, for example by exchanging the outer part, the gap dₐ of the auxiliary elongated opening can be set. The gap dₐ is typically between 0.1-1.5 mm, and is manufactured according to the coating requirements of the final product.

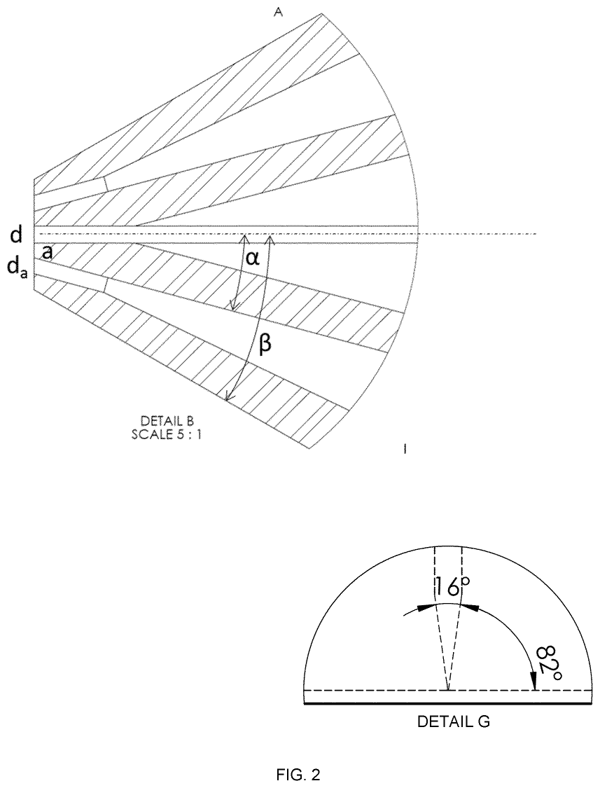

The inner part and outer parts may be made via milling, moulding, 3d printing or the like, as well known to a person skilled in the art. To achieve the required gap and to add supports for stiffness the outer parts are preferably machined from mild steel. The outer part is divided into sections by supports perpendicular to the nozzle opening for stiffness. These supports may be used for mounting the outer part to the inner part. The supports are preferably chamfered 8 degrees (FIG. 2, detail G, top view) at the nozzle opening to prevent vortex shedding. The jet opening on the auxiliary nozzle can be milled to achieve the required gap dₐ. Following machining/milling the outer part may be treated to harden the surface.

In order to realize a high impingement pressure on the strip, and hence a high wiping efficiency, the inner nozzles lips are at an angle α of 15° with respect to the centre line 50 and the outer nozzle lips are at an angle β of 30° with respect to the centre line 50 (FIG. 2, detail B, side view). The nozzle lips may be milled at the nozzle opening to obtain the desired gap width of the primary nozzle (d), the desired gap width of the auxiliary nozzle (dₐ) and the separation (a) between the main- and auxiliary jets. In FIG. 2, detail B, the nozzle lips are milled as such that the primary nozzle gap width is 1.0-1.5 mm, the auxiliary nozzle gap width is 1.0-1.5 mm and the separation (a) is 1 mm.

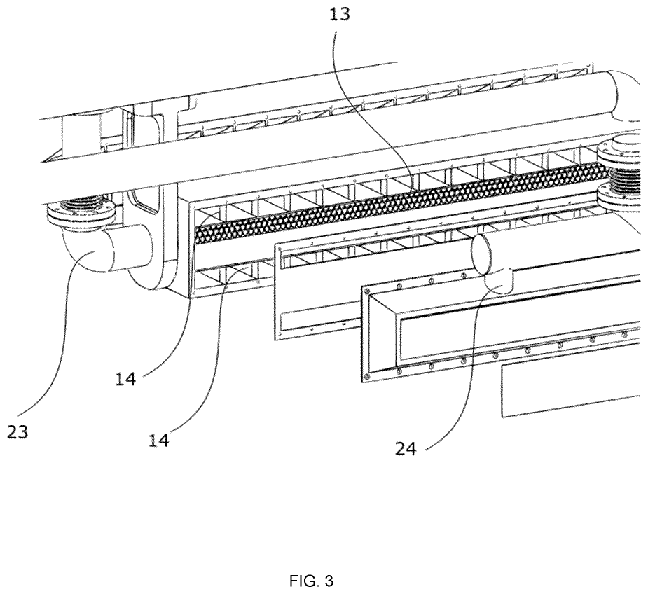

FIG. 3 shows an exemplary embodiment of the wiping device according to the invention, including a casing with two compartments, configured such that the first pressurized fluid (23) is guided through a first compartment (13) to the first elongated opening via the outer sides of the casing and the second pressurized fluid (24) is guided through a second compartment (13) via the back of the casing to the auxiliary elongated openings. In this particular embodiment, holes serve as calibration means in the first compartment, to break vortices present in the flow to the main nozzle. The second compartment comprises supports, preferably aligned with the supports of the outer parts of the nozzle system. The casing can be attached to the wiping device as common to the person skilled in the art. One possibility is to fasten the nozzle system and casing with fasteners, through openings (9) in the supports.

The modular design of the wiping device according to the invention, results in a device that can be easily assembled and disassembled, and can be used in a commercial galvanizing line. Furthermore, the wiping device can be fed with two separate air flows and has sufficient stiffness.

1. A multi-slot gas wiping device for controlling the thickness of a molten metallic coating on a moving metal strip, comprising
a nozzle system with a primary nozzle with a first elongated opening and two auxiliary nozzles each with an auxiliary elongated opening, wherein the primary nozzle and auxiliary nozzles are parallelly arranged, and
wherein the nozzle system comprises two nozzle components that are mirror images of each other and are attached together with a shim, thereby defining the first elongated opening with a gap width d, and
wherein each nozzle component comprises an inner part and an outer part, defining the auxiliary elongated openings with a gap width dₐ, and
wherein each inner part comprises an inner nozzle lip and two outer ends at the inner nozzle lip thereby forming an envelope and
wherein each outer part comprises an outer nozzle lip, two outer ends at the outer nozzle lip and a plurality of supports, wherein the plurality of supports are integrated in the outer nozzle lips with a perpendicular orientation to the outer nozzle lip and to a nozzle opening.

2. The gas wiping device according to claim 1, wherein the inner and outer part of the nozzle components are detachable connected.

3. The gas wiping device according to claim 2, wherein the nozzle components are detachable connected.

4. The gas wiping device according to claim 1, wherein the gap width dₐ of the auxiliary elongated opening is between 0.2-3 mm, and wherein the gap width dₐ is defined by an offset at the outer ends at the outer nozzle lip or by an indentation of the outer nozzle lip.

5. The gas wiping device according to claim 1, wherein the outer part is made in one piece.

6. The gas wiping device according to claim 1, wherein the inner nozzle lips are at an angle α in the range of 10-20° measured from the centreline and/or wherein the outer nozzle lips are at an angle β in the range of 20-40° measured from the centreline.

7. The gas wiping device according to claim 1, wherein the plurality of supports are chamfered at the nozzle opening at a range of 4-12°.

8. The gas wiping device according to claim 1, wherein the first elongated opening is fed with a first pressurized fluid and the auxiliary elongated openings are fed with a second pressurized fluid.

9. The gas wiping device according to claim 8, further comprising a casing with two compartments, configured such that the first pressurized fluid is guided through a first compartment to the first elongated opening and the second pressurized fluid is guided through a second compartment to the auxiliary elongated openings.

10. The gas wiping device according to claim 9, wherein the casing comprises gas inlets at the outer sides in fluid connection with the first compartment.

11. The gas wiping device according to claim 9 or 10, wherein the first compartment of the casing comprises calibration means for reducing vortices.

12. The gas wiping device according to claim 9, wherein the casing comprises a gas inlet at the back in fluid connection with the second compartment.

13. The gas wiping device according to claim 9, wherein the second compartment of the casing comprises a plurality of supports.

14. The gas wiping device according to claim 13, wherein the plurality of supports of the casing are aligned with the plurality of supports of the outer part of the nozzle components.

15. The gas wiping device according to claim 13, wherein the plurality of supports of the casing are chamfered at the gas inlet at the back.

16. The gas wiping device according to claim 1, wherein the gap width dₐ of the auxiliary elongated opening is 0.3-1.5 mm, and wherein the gap width dₐ is defined by an offset at the outer ends at the outer nozzle lip or by an indentation of the outer nozzle lip.

17. The gas wiping device according to claim 1, wherein the inner nozzle lips are at an angle α in the range of 10-20° measured from the centreline.

18. The gas wiping device according to claim 1, wherein the outer nozzle lips are at an angle β in the range of 20-40° measured from the centreline.
